(19) United States
(12) Patent Application Publication
(10) Pub. No.: US 2006/0151044 A1
(43) Pub. Date: Jul. 13, 2006

(54) Pipe, method and device for improved pipelines and similar objects

(76) Inventor: Alexandr Efimovich Gurov, MOSCOW (RU)

Correspondence Address: Ilya Zborovsky, 6 Schoolhouse Way, Dix Hills, NY, 11746, US

(21) Appl. No.: 10/524,303

(22) PCT Filed: Aug. 21, 2003
(86) PCT No.: PCT/RU03/00375

§ 371 Date: Feb. 4, 2005

(30) Foreign Application Priority Data
Aug. 21, 2002 (RU) 2002122419

(51) Int. Cl. F16L 11/00

(52) U.S. Cl. 138/129; 138/134; 138/122

(57) ABSTRACT

The invention relates to pipes, pipelines and similar objects and can be used in aviation, metallurgy, shipbuilding etc. Its task is to raise fault withstandability of s design. The task is solved in that a pipe has at least one conductive spiral layer for control and repair of a wall with the use of a laser. A layer in the wall is shaped by knurling and the knurl is filled with glass which is examined by optical vibrations and the wall defect is determined. The layer pitch is limited. The defect distance is found over the pipeline length and by the time of optic pulses run. The crack is healed by vibration heat in its opening. There are other differences including those in the device.

The invention related to pipes, pipelines and similar objects and may be used in aviation, metallurgy, shipbuilding, oil-and-gas, rocket-and-space, chemical and other industries.

There are known pipes assembled into pipelines by welding, mechanical tensioning or with the use of thread [1]. And pipes with threaded joints contain a cylindrical shell and end threads. A drawback of all these articles is their low controllability and high labor intensity of repair which causes great losses in the industry, also due to stoppages in pipeline operation, since the design of the cylindrical shell does not ensure proper functions.

There is a known method of oil pipelines checking lying in that a sensor cable is installed in the vicinity of a pipeline (oil storage, tank for storing oil products), the sensor cable is connected to a monitor and, based on monitor readings, a leakage on the pipeline section [2] is detected. The method determines through defects without stopping the oil pipeline operation and with no access to the structure. It is based on the separation of sensor cable cores by a synthetic dielectric soluble by oil. Oil changes conductive properties of this sensor, which is tested by a computer in a cyclic manner, and this is registered, processed and presented on the display screen by hardware and software facilities of the monitor. Detection of a leak (oil pipeline failure) may be significantly delayed. For example in the cold time of a year in the case of a small leak, when ground behind the bed freezes around the pipe, oil that goes out from the pipeline becomes heavy and its mobility worsens which is very common for oil fields of the north of Russia. This mostly depends on temperature of the volume which leaks for a unit of time, rate of product spreading, distance from the leakage to the sensor and rate of such dielectric dissolution. Although non-through injuries occur more often, the method can “see” only the violation of shell separating function in the course of operation. The place of leakage is not detected accurately, and this makes the repair of a section more difficult and expensive. It should be noted finally, that this solution fails to operate at water-, steam lines and other projects.

A device for realizing the method contains series-connected perforated tube, sensor cable containing two insulated conductors and monitor [2]. It is not efficient enough due to the influence of electromagnetic interference. They are eliminated with the aid of a control cable whose dielectric material is not dissolved by hydrocarbons, and the monitor that takes readings from the cables. A leakage signal appearing at one cable is registered without difficulties.

The closest in terms of engineering method to the proposed one is a method for checking oil- and gas pipelines of large diameters consisting in that the pipeline is examined mechanically by a piston moving in it, its location over the pipe length and values of wall physical fields are registered by piston control equipment and, after examining of the registration parameters, wall defects and their characteristics in the pipeline [3, 4] are indicated. This method reveals developing wall defects and defects that are hazardous, since it provides a possibility to determine the sizes, increments, development rates and locations of defects. Thus it is supposed that failures are ruled out, however, operating expenses due to the check and repair of objects required at eliminating a detected defect and its omission are not duly taken into consideration. Internal access to the pipe is required, its provision with pig catchers and launchers, computer network and fundamental software and provision with metrological data. A drawback of this method, as well as the method mentioned above, lies in its insufficient reliability. The reasons are as follows:

1) Coefficients of detectability and defect forecast fail to achieve maximum values here. Mostly this is due to electronic measurements of signal/noise relation, and also methodological and instrument errors of non-destructive test including the problems of defect-to-pattern comparison (shape, size, orientation and location relative to welds, zones of thermal influence and pipeline generating lines—upper, lower ones), error in measuring a distance to defects etc.;

2) Examination with a piston is considerably longer that the testing of a sensor cable with computer and fails to reveal transition of a developing defect to the category of hazardous one. The transition appears at the moment, as the defect achieves a near-critical size (Griffit's condition) but it is not determined in time. This is due to the differences of physical-and-mechanical properties of material, wall thickness, its corrosion, static-and-dynamic load, and so on. The minimal period of the method is predetermined by a sum of section control periods, a return to the initial point and piston preparation for a new examination regardless of the time of reset and data processing in the network. A real period of object investigation exceeds 2 to 3 years. And such a well-known defect as a crack which, in particular, is a potential source of failures and severe accidents in gas pipelines, grows in incidental jumps that occur at unpredictable moments. And the jump rate which is less than the rate of ultrasound in steel, exceeds the speed of piston movement by 2 to 3 orders of magnitude. The value of a jump is not limited: 10%, 400-500% and more of a critical size—near the transition point, a so-called trunk crack. In accidents at gas lines it achieves a length of 1 km, in oil lines—several meters;

3) Faultless operation of a piston is impeded by its complexity. It contains [3, 4] a tight sectional structure which is under medium pressure with explosion-, fire-, toxic- and other hazardous properties; a drive with a device for location measurement; high-precision analog-digital channels; a special computer with software; sources of stable power supply; printed-circuit boards, connectors and soldered joints; ultrasonic, electromagnetic and other types of sensors for detecting abnormalities in the wall material; a magnetizing device and so on. Moreover, all this should operate in conditions of annual temperature difference of 70-90° C. which complicates the problem.

There are known method and device for the repair of pipelines [5] based on pipe external reinforcement. In this method the place of pipeline injury is localized to the formation of the trunk crack, and the pipeline is strengthened before the sealing of an injury after reducing pressure [5]. The device contains not less than two seals in the form of supporting spiral elements wound on the pipe at both sides of the crack, some other parts are included in it [5]. A drawback of such recovery of a pipeline lies in its relative labor intensity, since it requires delivery of equipment and workers by transport to the place of damage, excavation work round the pipe, repair proper and other things.

There is also a known method of control and recovery of objects damaged by scores [6]. A coating is applied on a plate with recesses, the data in a special track during recording are alternated, and are recovered by preset features during the reproduction of information [6]. The CD recorder contains a laser, drivers, a prism, a photodiode, coders, memory circuits and other elements [6]. A drawback of this complex process is plate rotation which restricts its use by moving objects.

In the light of the above the known engineering solutions on functions, methods and devices of control and repair of objects potentially cannot ensure faultless operation of oil- and gas pipelines, and this causes (and will cause) significant losses of material, production, feedstock, foreign-exchange and finance and other important damage. There are more than enough examples of it in various countries.

The task of the invention is to raise resistance to failures of pipes, pipelines and other similar important objects by way of determining defects and by reinforcement of injured walls in real time. The subtasks are:
imparting properties of industrial controllability to a cylindrical shell including opportune and accurate determination of location, size and rate of defect development;
properties of recovering and decreasing labor intensity of the repair of an injured wall.

The task is solved in that a known pipe [1] has at least one optically conductive spiral layer for wall inspection and repair. The pipeline is assembled of pipes wherein the said layer is implemented in the wall in the form of a groove filled with sand. In the method of pipeline check adopted as a prototype [3] lying in that a pipeline is examined, characteristics of the wall are registered and its defects are determined characterized by that at least one conductive layer is formed in the pipeline by knurling and knurl filling with glass, it is examined by optical vibrations, and wall defects are determined by the change in vibration parameters. Besides, a layer helical lead is selected to be not in excess of the pipeline critical crack length. The distance to the defect is determined as a product of the pipeline length multiplied by the ratio of optical pulse run periods before and after defect occurrence. Layers of varying deformability are formed, and the period of pipeline failure is determined by calculation according to the values of layers and wall deformability and moments of layer destruction. In the methods of pipeline repair [5] lying in that the pressure in the cavity is reduced and the defective wall is recovered, characterized by that, like in the pervious method, the said layer is formed in the pipeline, examined but according to the changes in optical vibrations the pressure in the cavity is reduced, and the defective wall is recovered by the heat of vibrations put by the layer into the crack opening. The heat flow into the crack opening is regulated by the power of vibrations transmitted. The power of the transmitted vibrations is increased by steps. At the same time the device for implementing the method [2] containing a sensor and monitor characterized by that it is fitted with series-connected uninterruptible power supply unit, dc-to-ac voltage converter and an optoelectronic couple that is connected with the sensor by a fiber-optic line forming a conductive layer of the pipeline and with the first monitor inlet, the second monitor inlet is connected to the outlet of the dc-to-ac voltage converter. Another version of the device has a radiator in the optoelectronic couple in the form of a laser—semiconductor laser.

The author is not familiar with similar solutions of the inventor's task in this field of engineering or in other closely related fields. Therefore he considers significant the aggregate of distinctive features set forth herein.

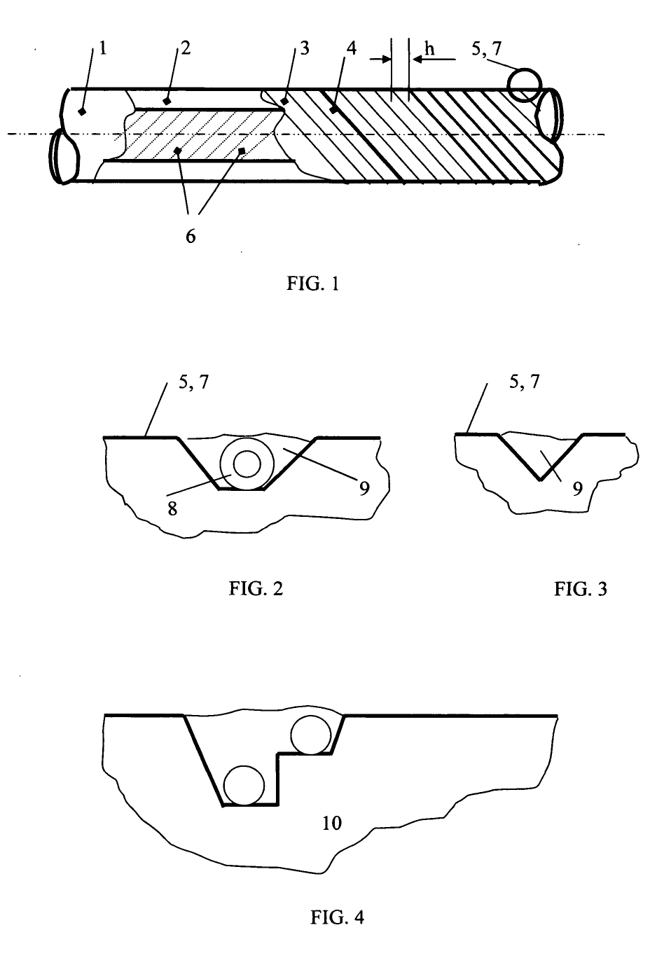

The invention layout is thoroughly represented in FIGS. 1 to 6.

Shown in FIG. 1 are pipe versions with a conductive spiral layer, where 1—pipe (pipeline), 2—wall, 3—external spiral surface, 4—external indicated layer, 6—internal spiral surfaces (one is a layer);

Shown in FIG. 2, FIG. 3 and FIG. 4 are magnified sections of the spiral layer, where 5—the border of the external spiral surface, 7—the border of the internal spiral surfaces, 8, 9 and 10—sections of optical fiber, epoxy matrix and double layer in a groove.

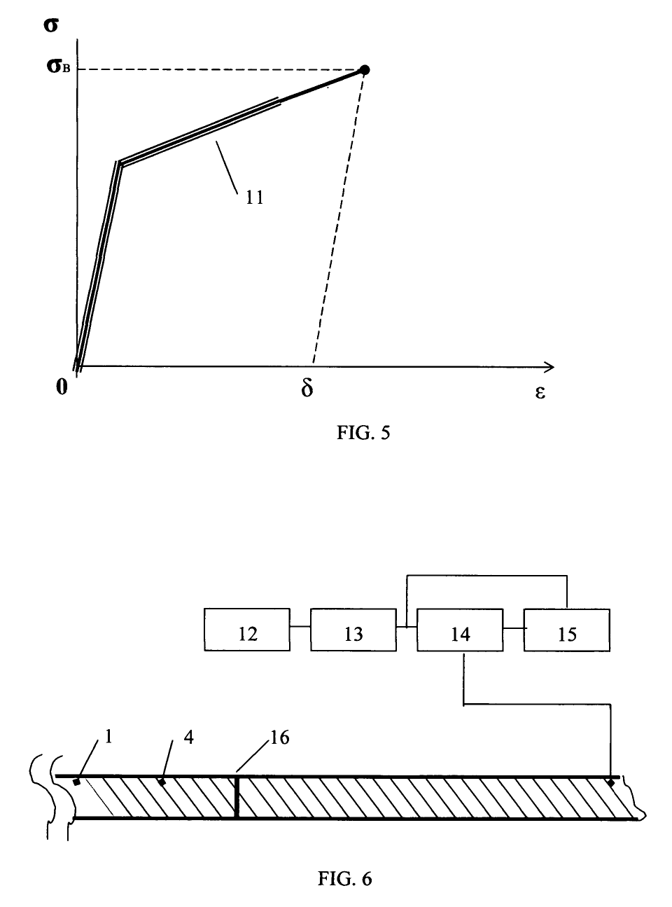

Shown in FIG. 5 is approximated diagram of steel stretching, where σ_{b}—ultimate strength, δ—elongation at breakage, 11—butt joint area for pipes with the conductive spiral layer of glass.

Shown in FIG. 6 are the layout and device for checking pipelines and similar objects.

Designations of the diagram comply with FIG. 1. The device contains series-connected uninterruptible power supply unit 12, voltage dc-to-ac converter 13, optoelectronic couple 14 and monitor 15 which is connected with its other inlet to the outlet of converter 13. Couple 14 is connected with the conductive spiral layer 4. 16—is a welded joint of pipes.

The invention consists in the following. Pipe (and other articles based on a structure of a cylindrical shell) has, at least, one optically conductive spiral layer (hereinafter referred to as CSL) for wall check and repair (see FIG. 1). With the purpose of industrial control and early recovery pipelines and similar responsible objects are fitted with CSL-s in the wall in the form of a groove filled with solid substance transparent for magnetic vibrations, e.g. glass. Such objects are obtained by assembling from the aforesaid pipes (shells) and in another way. With this view a known spiral surface (pos. 1 of FIG. 1) is formed in the pipe (positions 3, 4, 6 of the same figure), for example, by knurling, with a pipe tap or by evaporating a part of the steel wall (position 2, the same figure) by a focused laser beam. Filling (position 8 of FIG. 2) of obtained surface with glass is realized, in particular, by winding the fiber of communication optical line to the groove (hereinafter referred to as FCOL) fastened to the wall by adhesive (including epoxy glue—position 9, the same figure). To this end the piston (not shown in the figures) is fitted with corresponding technological rigging. These operations are more efficient at factory conditions, since layers there are obtained with the use of high-efficient process equipment (thread-cutting, winding and other means).

Coefficient of the use of metal in forming the groove by a thread is minimal. However, the internal layer (position 6 in FIG. 1) reveals (which is not accessible to the external one) abrasive wear of a gas line with mechanical inclusions in the flow of natural gas, since the wall is scratched by solid particles and is gradually wedged out.

Forming is realized along a spiral line whose pitch (position h of FIG. 1) is restricted, in particular, by a half length of the cylindrical shell critical crack loaded with internal pressure, which makes it possible to opportunely determine 100% of hazardous longitudinal cracks in a pipeline and its other operation faults. The value of this pitch is calculated, for example, by the following formula:
h≦WE/πσ²,

where
W—specific work of pipeline destruction;
E—Young's modulus of material;
σ—average stretching stress.

The knurl (groove), for a example, is given a trapezoidal section (positions 5, 7 of FIG. 2, 3) with the average width 1 to 10% of its helical lead. Such section needs lesser accuracy in machining, when placing a finished optical cable in the groove and to a lesser degree concentrates pipe stresses, i.e. it is better to have a triangular geometrical shape of the section. CSL pitch is permanent as a rule. The depth (height) of the groove is established with account of a number of considerations: wall thickness, when manufacturing pipes, is selected on the basis of reliability conditions, i.e. thread and grooves should not decrease the section that should withstand calculated values; FCOL should not go beyond the pipe wall to rule out injuries during pipeline construction and pipe transportation. Only a shallow groove is required for a single fiber, e.g. 0.3-0.7 mm. Pipes may be fitted with factory-made (construction) insulation. The stretching of a steel pipeline and CSL should be technologically coordinated with each other, i.e. mechanical destruction of glass should correspond with the beginning and/or development of plastic strains (see FIG. 5). Such a subject is reliable throughout a wide range of temperatures due to approximate equality of temperature linear expansion coefficients of both constructional materials. Stretching values are, for example, agreed by placing FCOL on a pipe (with a groove) that has been preliminarily loaded by internal pressure. The level of pressure is established, in particular, when optimizing pipe production, by the values of yield line of pipe steel (position 11 of FIG. 5) and deformation of fiber 2-5%) at the moment of its destruction. The operation is implemented, for example, after calibration (expanding) of thin-walled pipes around the diameter. In the course of fiber glass winding to the groove a small mechanical stress is applied. Layers of two CSL-s (they are near each other on the pipe, position 10 of FIG. 4) with different extensions at rupture (deformability features) determine additionally the rate of defect development, because two kinds of time marking become known (t₁, t₂) at the moment of layer destruction. A layer with lesser deformability breaks down first (δ₁), the second—with bigger one (δ₂). For example, if a pipeline of a heating main is made of steel with deformability (δ₃), condition δ₁<δ₂<δ₃ is observed. An object is supposed to operate in a stationary mode. The forecast of pipeline failure time for which the distance to a defect in the case of measurements with the use of 2 layers have coincided, is performed by a calculation. Let us take, for example, the model of yield line (FIG. 5) of pipe steel, (t₃−t₂)=(t₂−t₁)×(δ₃−δ₂)/(δ₂−δ₁). If we assume that (t₂−t₁)=10 days, (δ₂−δ₁)=5%, (δ₃−δ₂)=10%, the rated time (t₃−t₂)=20 days. Before the expiry of this period from the moment of time t₂, in particular, with a 2-3-day reserve, measures are taken to prevent an accident. This is important for hazardous objects within the city area, at an intersection with a railway, etc. With regard to shells with CSL, a theory of fragile strain-sensitive coatings is suitable. Varnish coating at calibration gives a 10-20-% accuracy of detecting strain-stress distribution of mechanical products. For a single-layer FCOL an identity of the strength of optical fiber sections (lots) is not required. More important that this physical value would be in the area of plastic strains of steel pipe of 0.5 to 27% of its initial diameter with consideration for steel quality and availability-absence of calibration operation), since it is this “plastics” that is an indispensable attribute of defects sought. Depending on the method of layer placement, provision should be made that the fibers with adhesive filler in the groove (positions 8, 9 of FIGS. 2, 3, 4) would work well for compression which is observed by a number of constructional materials including glass and epoxy matrix.

As a result of the above-described operations a check test piece (reference sample) of object degree of injury is obtained. The metrology of the proposed approach is based on metric properties of helical surfaces, theory of fragile coatings, regularities of fracture mechanic for a given cylindrical shell with a defect loaded with internal pressure, and a possibility of observation (examination) of the state of a check test piece in space and time.

This check test piece is examined by optical vibrations, in particular, by transmitting optical pulses with known parameters through it. For a high-quality pipeline an electromagnetic wave is propagated in CSL with a certain constant specific attenuation without any sensible obstacles on its way (for example, for FCOL of 125μ in diameter with the wave length about 1.6μ an attenuation coefficient 0.2 dB/km is known). In the end of a pipeline the wave is reflected on the surface boundary and runs back). The periodic process is weakened with time and stops. A direct or return wave is registered in the points at objects ends. For long sections investigation over the direct wave is more efficient, as it attenuates to lesser extent compared to a reflected one. The direct wave is registered in a point at the opposite pipeline (section) end relative to the point of pulse introduction. A reflex wave is directly in the input point. Wave distribution is conducted, in particular, according to the time feature. For example, for a 1000-m section of 350 mm in diameter, pitch of helical surface of 20 mm and the known rate of electromagnetic wave propagation, the delay of the reflex wave relative to a direct one will amount to about 0.25 ms. Other methods of separation are possible or the use of several separation methods.

An injure layer, for example, in the case of defect appearance in a pipe, when in service, reflects a part of the wave in the point of material continuity violation, the other part is transmitted further. The relationship of the parts depends on the nature of an injury, i.e. on defect parameters. In the case of control by the direct wave method its amplitude in the reading point decreases accordingly. However, this decrease may be a result of a number of CSL violations, for example, a chain of various defects. The depth of a defect is not registered, i.e. this value should be regarded greater that the diameter of optic fiber used (or the depth of groove where it is placed).

To provide for the accuracy of observation of the pipeline state attributed with a feature of industrial controllability, the value of the calculation pitch is established . . . 0.2 h, 0.3 h, . . . 0.7 h . . . kh, i.e. the, dimension of a non-hazardous defect is checked, and a forecast of the residual service life is made. Coefficient k≦1 can be coordinated with the branch coefficient of strength margin of a shell-like structure. Accident-free performance of an object is ensured, for example, by reducing pressure in it 1.5 to 2 times as much with the use of an automatic action of the gas transportation control system by the feature of examination wave (direct, reflex one) absence (i.e. change) in corresponding points of the pipeline or by a command from system operator (not shown).

The distance to the defect is found by the product of shell length by the relation of the optical pulses traveling times in CSL after and before defect appearance. For example, this distance for a pipeline of length L=10 km and pulse traveling time after and before: t=25 μs, T=1000 μs respectively, will amount to, as it follows form mathematical formula X=Lt/T, from one of pipeline ends, 0.25 km. The distance at continuous optical fluctuations is determined (specified) by a phase method.

Pulse repetition is restricted by a value obtained from dividing a double length of the helical surface by the rate of electromagnetic wave propagation in CSL. In particular, selection is made from the necessary alarm time: one time per second, minute etc. which makes it possible to determine the moments of occurrence and achievement a preset value by the defect.

After registering parameters of vibrations depending on a situation “whether a change in a parameter takes place or not” availability of absence of wall defect is established. The geometrical dimension of a defect detected under conditions specified according to the description text is approximately h. In individual cases, depending on defect shape and location relative to spiral turns, “brittleness” of its material, the dimension will be less, for instance, for a surface crack symmetric to a turn.

Advantage of a two-point input (points on pipeline ends), that considers independently CSL division into parts—absence of the necessity of layer urgent repair. It is important from the point of view of convenience and efficiency of operating a spatially distributed system of pipeline 1. Equality of the number of input points to the number of cock platforms (of compressor or pumping plants) of an object controlled is possible. The decision in this case will probably be optimal. Its reliability is higher at the expense of doubling (reserving) input points, however, the repair of the section immediately after defect indication ensures control from one point.

CSL does not feel initial defects of minor significance, for example, corrosion that may occupy a large surface of an object. It reacts only to defects that cause a local change in the stress-strain state of a combined structure which is equal to or exceeds the lengthening of a layer in case of a rupture, and in the given conditions this is an adequate feature of its impermissible injury. Defects that are not hazardous at the moment of pipeline operation examination, do not produce false actuations that diminish control as a process operation.

The device for control of pipelines and other objects operates in the way as follows (see FIG. 6). Uninterruptible power unit 12 (batteries complete with a power line, gasoline-, power station and rectifier) ensure energy for the elements of the device regardless of interruptions in power supply. Converter 13 issues preset vibrations (pulses) with the aid of optoelectronic couple 14 (implemented, for example, with a laser radiator, photodetector and prism), to FCOL 4 (sensor) of pipeline 1, and from the line—to monitor 15. The variables of optical pulses do not change while injuries that are growing for the time of object operation are less than h. When the size of any of them reaches h, CSL is striving to a defective point, and the time of optical pulses traveling decreases in proportion to defect position along the pipeline. This is registered and recalculated by means of monitor 15 (device of sampling-storage, analog-digital converter, computer, system and subject software, drivers) to the distance to a defect according to the description mathematical formula. The device is not influenced by electromagnetic interference—spectra of useful and parasitic vibrations are considerably spaced apart. The laser of the semiconductor couple 14 (that radiates pulses with duration to 10⁻⁹ with the power to 10⁵ W, efficiency of 40% to 60%) in the range of wave length of 0.3 to 30μ, makes the device more reliable and durable which is not ensured at continuous vibrations due to a thermal overheat. The error in finding the distance to the defect (longitudinal coordinate) is preset by not only a layer pitch, since relative error of laser measurements (standard of a second ≈10⁻¹², meter ≈10⁻¹⁰) is very small. The error of an angular coordinate may be less than 1 to 3 deg.

It follows from the previous operations and recommendations that coefficient of defect detectability depends on the relation of pipe length with CSL to its full length. For example, (see diagram and pos. 16 in FIG. 6) a part of cylindrical surface for the edges of the butt weld without spiral gives for the 12-m section with 2-cm edges the rated K_{dd}=0.996(6), with 1-cm edges—0.998(3). In the case with a full spiral K_{dd}=1. When installing pipelines by known methods CSL is jointed by welding, bonding. Thus the subtask of the check is solved, and refusal of the structure due to an operation defect is actually ruled out, service life of objects increases.

With the purpose of healing and early repair of crack-like abnormalities of wall material in the known methods of pipeline [5] repair, similarly to the checking method that has just been set forth, the said layer is formed, examined by optic vibrations, and changes in their parameters are investigated. According to these changes the pressure in the cavity is reduced (see extract on control system and operator), for example, with a valve, and the defective wall of the pipeline 1 is recovered by the heat of optic vibrations transmitted by the layer into crack opening.

Since CSL, as it follows from the above substantiation, has been already destructed by the crack, and attenuation of the optical vibrations in the layer (as was noted in describing pipeline examination with electromagenetic waves) is low, a part of energy of the focused laser radiation spreading in such waveguide, is automatically concentrated by it (due to the groove) precisely into the crack opening, and is relaxed there at the expense of multiple reflections and associated losses.

This causes efficient heating of crack edges and areas of wall 2 adjacent to them without metal evaporation. In this case the crack is not developed, since it is protected by the action of elastic strains in the wall due to the reduction of the working pressure of object 1 implemented earlier. The heat flow into the opening is regulated by the power of optical vibrations transmitted through the layer, for example, by the use of vibrations from two inlet points which quite complies with the proposed method of control, by connecting continuous lasers of high generating capacity, etc.

Temperature, rate or time of heating are determined by wall materials and selected experimentally. To reduce mechanical stresses in the defect area (earlier repair) the time of heating (cooldown) is selected, for example, by duration and number of laser pulses transmitted through the layer per second. For the sake of integrity of optical fiber that is heated near the defect (to avoid its new breaks and, accordingly, additional wave energy losses for reflecting back to the layer) the power of transmitted optical vibrations is increased in small steps changing the amplitude or time of vibrations.

Crack edges are brought nearer to each other and realize a contact interaction, i.e. welding. The crack boundary sweats and gets smoothed which causes, after cooling, losses of wall material continuity in the point of recovery. Healing is possible in structures of aluminum and its industrial alloys, copper and some alloys of the latter, like bronze, brass, other metals and thermoplastic materials.

For steels and materials with the melting point higher than the temperature of glass softening wall repair is implemented by filling the groove (knurl) with glass, i.e. one of welding operations—soldering—takes place. Besides, the reserve (section) of CSL glass produces effect. The crack itself acts as a groove. Such recovery of the wall makes it possible to do without emergency stoppage of the pipeline and similar objects promoting the cessation of spending, and it is ensured by a diagram 3 and device presented in FIG. 3.

For nearest analogs and prototype this means the acceleration of repair and decrease in its preparatory and process time.

The effect of the proposals is maximum, when used at industrial, transport and other objects operating in conditions of hazardous pressure of media, for example, at trunk gas- and oil pipelines. It is less at heating mains and other structures, where these factors are weaker, destructions by cracks are not dominating, and CSL pitch may be determined in consideration of medium dimensions (diameters) of corrosion blowholes on the basis of examination results. Welding defects can be taken into account by decreasing h in the area of joint 16. Expenses for economic effect with consideration for completeness and implementation of alternatives are expected to be at the level to 10% of the cost of pipes of a similar pipeline without the proposed functions. Approximately the same is true for articles like high-pressure tanks, gas holders, tanks for petrochemical products, casings of various purposes, vessels, vats and so on.

Thus the invention improves considerably the named objects, raises their reliability and safety, efficiency of production, improves the ecology and integrity of human environment.

Sources of information taken into account at the expert examination
1. NATIONAL STANDARD OF CANADA. CAN3-Z163-M86. OIL PIPELINE SYSTEMS./CANADIAN NATIONAL STANDARD.
CAN3-Z183-M86. SYSTEMS OF OIL PIPELINES. (TRANSLATION). (The translation is made by the scientific-engineering center “Neftepromdiagnostika”) city of SAMARA. “Samarsky dom” Publishers 1994, 196 p.
2.3. Kollakot R. Diagnostics of injuries. Translated from English, M.: Mir, 1989, p. 220-222, 440-443 (prototype).
4. Engineering means of diagnostics. Reference book/Under general editing of V. V. Kliuyev.-M.: Mashinostroeniye, 1989, p. 610-612.
5. Patent of the RF No. 2118738 for invention “Method and device for the repair of pipelines”. Published on 10.09.1998, Bull. No. 25.
6. Sinclair Yan. Introduction into digital sound engineering: Translated from English, M., Energoatomizdat, 1990, 80 p.

1-18. (canceled)

19. A pipe, comprising a spiral for checking and/or repair of a wall, said spiral having a helical lead selected so that it does not exceed crack critical length of a pipe with a weld.

20. A pipe as defined in claim 19, wherein at least one additional spiral is provided and has a similar direction as said first mentioned spiral.

21. A pipe as defined in claim 19, wherein said spiral is formed in a wall in form of a groove filled with vitreous mass.

22. A pipe as defined in claim 19, wherein said spiral is formed in a wall in form of a convex layer of vitreous mass.

23. A method of pipeline checking, comprising the steps of checking a pipeline with a spiral; registering characteristics of a wall and its defects by means of a conductive spiral arranged in the wall; and selecting a helical lead of the conductive spiral so that it does not exceed a crack critical length of a welded pipeline.

24. A method as defined in claim 23; and further comprising providing at least one additional conductor spiral in a same direction as said first mentioned spiral on the pipeline wall.

25. A method as defined in claim 23; and further comprising forming the conductive spiral by knurling in form of a groove filled with vitreous mass.

26. A method as defined in claim 23; and further comprising arranging the conductive spiral on the wall in form of a convex layer of vitreous mass.

27. A method as defined in claim 23; and further comprising determining a distance to a defect by a product of a pipeline length and a relation of measuring pulses traveling before and after defect appearance.

28. A method as defined in claim 23; and further comprising forming layers of varying deformability; and determining a period of pipeline failure by calculation on a basis of deformability of the layers and a wall, and a time of layers destruction.

29. A method of pipeline repair, comprising the steps of reducing a pressure in a pipeline cavity; restoring a defective wall of the pipeline; forming at least one spiral in the pipeline with a spiral helical lead selected not to exceed a crack critical length of a welded pipeline; examining the spiral for determining a defect in a pipeline wall; by changes in measuring pulse vibrations reducing a pressure in a pipeline cavity; and restoring a defective wall by heat of vibrations transmitted by the conductive spiral into a crack opening.

30. A method as defined in claim 29; and further comprising arranging at least one additional conductive spiral on the pipe wall in a same direction as the first mentioned spiral.

31. A method as defined in claim 29; and further comprising forming the conductive spiral by knurling in form of a groove which is filled with vitreous mass.

32. A method as defined in claim 19; and further comprising arranging the conductive spiral on a wall in form of a convex layer of vitreous mass.

33. A method as defined in claim 29; and further comprising regulating a heat flow into the crack opening by a power of transmitted vibrations.

34. A method as defined in claim 33; and further comprising increasing a power of the transmitted vibrations in stages.

35. A device for realizing a method of claim 29, comprising a sensor and a monitor, series-connected power unit, DC-to-AC voltage convertor, radiator an optoelectronic couple which is connected with the sensor in form of a fiber-optic line and with a first inlet of the monitor, wherein a second inlet of the monitor is connected to an outlet of the DC-to-AC convertor, wherein the fiber-optic line is formed as a layer of vitreous mass formed at least by a section of one conductive spiral on the pipeline, and a distance between neighboring turns of the spiral is selected not to exceed a crack critical length of the welded pipeline.

36. A device as defined in claim 35, wherein the radiator of the optoelectronic couple is formed as a laser.
